(19) United States
(12) Patent Application Publication
(10) Pub. No.: US 2026/0163325 A1
(43) Pub. Date: Jun. 11, 2026

(54) Variable Diameter Gain Coil

(71) Applicant: II-VI Delaware, Inc., Wilmington, DE (US)

(72) Inventors: Eric Green, Corning, NY (US); Thomas W. Mcnamara, Corning, NY (US); Bradley Dailey, Painted Post, NY (US)

(21) Appl. No.: 18/969,381

(22) Filed: Dec. 5, 2024

(51) Int. Cl. H01S 3/067

(52) U.S. Cl. CPC H01S 3/06704

(57) ABSTRACT

A coiling structure for a laser fiber includes a body having a central axis, a first radial channel in the body positioned at a first radius from the central axis, a second radial channel positioned at a second radius from the central axis, and a transition section connecting the first radial channel to the second radial channel. The second radius is larger than the first radius. A laser fiber is wound in the coiling structure, with a first portion of the laser fiber wound in a first coil in the first radial channel of the coiling structure, a transition portion of the laser fiber extending through the transition section of the coiling structure, and a second portion of the laser fiber wound in a second coil in the second radial channel of the coiling structure.

### BACKGROUND OF THE DISCLOSURE

### 1. Field

This application relates generally to coiling structure for a laser fiber; and more specifically, to a variable diameter coiling structure for a laser fiber.

### 2. Technical Considerations

Fiber lasers have become essential in many high-power laser applications due to their efficiency, compact design, and ability to deliver high-quality beam profiles. A common component of fiber lasers is a gain coil, which amplifies the optical signal passing through the laser fiber. In the gain coil, the core modes of the optical fiber must be carefully managed to optimize the beam quality and prevent nonlinear effects, such as stimulated Brillouin scattering (SBS).

To achieve optimal performance, laser fiber is often coiled with a small radius in the first few meters near the signal input. The tight coiling serves to filter out higher-order core modes, ensuring that only the desired fundamental mode is propagated. This mode filtering is critical when the gain is high because higher-order modes can become amplified and degrade the beam quality. The tight coiling is effective at the front end of the gain coil because the signal power is relatively low, and nonlinear effects, such as SBS, are not a significant concern.

As the signal propagates along the laser fiber, it becomes increasingly amplified, with the signal power rising significantly towards the output end of the gain coil. In this high-power region, the risk of SBS may be a concern. SBS is a nonlinear effect that occurs when intense light interacts with acoustic waves in the fiber, leading to backscattering of the signal and potentially damaging feedback.

Conventional gain coil designs typically have a uniform coiling radius along the entire length of the laser fiber. This approach presents a trade-off between mode filtering and SBS suppression. Tight coiling throughout the entire laser fiber may effectively filter higher-order modes but also raises the risk of SBS as the signal power increases. Conversely, using a longer coiling radius throughout the gain coil may reduce the incidence of SBS but fails to adequately filter higher-order modes near the signal input, where mode control is most critical.

Accordingly, there is a need in the art for an improved gain coil design that provides effective mode filtering in the early stages of amplification, while also minimizing the risk of SBS at higher power levels.

### SUMMARY OF THE INVENTION

In view of the deficiencies in existing gain coils, there is a need for a solution that utilizes different coiling radii along the length of the laser fiber that provides effective mode filtering in the early stages of amplification, while also minimizing the risk of SBS at higher power levels, thereby addressing the limitations inherent in current uniform-coiling approaches. Disclosed herein are non-limiting embodiments or aspects of a coiling structure for a laser fiber and a laser fiber gain coil having the coiling structure that achieve the desired mode filtering effect.

In some non-limiting embodiments or aspects, a coiling structure for a laser fiber may include a body having a central axis; a first radial channel in the body positioned at a first radius from the central axis; a second radial channel positioned at a second radius from the central axis; and a transition section connecting the first radial channel to the second radial channel. The second radius may be larger than the first radius.

In some non-limiting embodiments or aspects, the body may include a first plate, a second plate, and a third plate coaxially aligned with the central axis. The first radial channel may be defined between the first plate and the second plate, the second radial channel may be defined between the second plate and the third plate, and the transition section may extend through the second plate.

In some non-limiting embodiments or aspects, the second plate may have a first protrusion extending axially outward from a first surface. The first protrusion may define an inner radial surface of the first radial channel. The first plate may also have a second protrusion extending axially outward from a second surface opposite the first surface. The second protrusion may define an inner radial surface of the second radial channel. A width of the first radial channel and the second radial channel in an axial direction may correspond to a diameter of the laser fiber. The first plate may have an inlet groove having a passthrough channel extending into the first radial channel. In some non-limiting embodiments or aspects, the body may be made from a thermally-conductive material.

In some non-limiting embodiments or aspects, a laser fiber gain coil may include a body having a central axis; a first radial channel in the body positioned at a first radius from the central axis; a second radial channel positioned at a second radius from the central axis, wherein the second radius is larger than the first radius; a transition section connecting the first radial channel to the second radial channel; and a laser fiber. The laser fiber may have a first portion wound in a first coil in the first radial channel, a transition portion extending through the transition section, and a second portion wound in a second coil in the second radial channel.

In some non-limiting embodiments or aspects, the first coil and the second coil may be planar coils or cylindrical coils. The first portion of the laser fiber may include a metal wire extending parallel with the first portion. The laser fiber may be a glass fiber having a polymeric coating.

In some non-limiting embodiments or aspects, the body may include a first plate, a second plate, and a third plate coaxially aligned with the central axis. The first radial channel may be defined between the first plate and the second plate, and the second radial channel may be defined between the second plate and the third plate. The transition section may extend through the second plate.

In some non-limiting embodiments or aspects, the second plate may have a first protrusion extending axially outward from a first surface. The first protrusion may define an inner radial surface of the first radial channel. The first plate may also have a second protrusion extending axially outward from a second surface opposite the first surface. The second protrusion may define an inner radial surface of the second radial channel. A width of the first radial channel and the second radial channel in an axial direction may correspond to a diameter of the laser fiber. The first plate may have an inlet groove having a passthrough channel extending into the first radial channel. In some non-limiting embodiments or aspects, the body may be made from a thermally-conductive material.

Various non-limiting examples and aspects of the present invention will now be described and set forth in the following numbered clauses:

Clause 1: A coiling structure for a laser fiber, the coiling structure comprising: a body having a central axis; a first radial channel in the body positioned at a first radius from the central axis; a second radial channel positioned at a second radius from the central axis; and a transition section connecting the first radial channel to the second radial channel, wherein the second radius is larger than the first radius.

Clause 2: The coiling structure according to clause 1, wherein the body comprises a first plate, a second plate, and a third plate coaxially aligned with the central axis.

Clause 3: The coiling structure according to clause 2, wherein the first radial channel is defined between the first plate and the second plate, wherein the second radial channel is defined between the second plate and the third plate, and wherein the transition section extends through the second plate.

Clause 4: The coiling structure according to clause 2 or 3, wherein the second plate has a first protrusion extending axially outward from a first surface, the first protrusion defining an inner radial surface of the first radial channel, and wherein the first plate has a second protrusion extending axially outward from a second surface opposite the first surface, the second protrusion defining an inner radial surface of the second radial channel.

Clause 5: The coiling structure according to any of clauses 1 to 4, wherein a width of the first radial channel and the second radial channel in an axial direction corresponds to a diameter of the laser fiber.

Clause 6: The coiling structure according to any of clauses 2 to 5, wherein the first plate comprises an inlet groove having a passthrough channel extending into the first radial channel.

Clause 7: The coiling structure according to any of clauses 1 to 6, wherein the body is made from a thermally-conductive material.

Clause 8: A laser fiber gain coil comprising: a body having a central axis; a first radial channel in the body positioned at a first radius from the central axis; a second radial channel positioned at a second radius from the central axis, wherein the second radius is larger than the first radius; a transition section connecting the first radial channel to the second radial channel; and a laser fiber having a first portion wound in a first coil in the first radial channel, a transition portion extending through the transition section, and a second portion wound in a second coil in the second radial channel.

Clause 9: The laser fiber gain coil according to clause 8, wherein the first coil and the second coil are planar coils.

Clause 10: The laser fiber gain coil according to claim 8 or 9, wherein the first coil and the second coil are cylindrical coils.

Clause 11: The laser fiber gain coil according to any of clauses 8 to 10, wherein the first portion of the laser fiber comprises a metal wire extending parallel with the first portion.

Clause 12: The laser fiber gain coil according to any of clauses 8 to 11, wherein the laser fiber is a glass fiber comprising a polymeric coating.

Clause 13: The laser fiber gain coil according to any of clauses 8 to 12, wherein the body comprises a first plate, a second plate, and a third plate coaxially aligned with the central axis.

Clause 14: The laser fiber gain coil according to clause 13, wherein the first radial channel is defined between the first plate and the second plate, wherein the second radial channel is defined between the second plate and the third plate, and wherein the transition section extends through the second plate.

Clause 15: The laser fiber gain coil according to clause 14, wherein the second plate has a first protrusion extending axially outward from a first surface, the first protrusion defining an inner radial surface of the first radial channel, and wherein the first plate has a second protrusion extending axially outward from a second surface opposite the first surface, the second protrusion defining an inner radial surface of the second radial channel.

Clause 16: The laser fiber gain coil according to any of clauses 8 to 15, wherein a width of the first radial channel and the second radial channel in an axial direction corresponds to a diameter of the laser fiber.

Clause 17: The laser fiber gain coil according to any of clauses 13 to 16, wherein the first plate comprises an inlet groove having a passthrough channel extending into the first radial channel.

Clause 18: The laser fiber gain coil according to any of clauses 8 to 17, wherein the body is made from a thermally-conductive material.

### BRIEF DESCRIPTION OF THE DRAWINGS

Various embodiments or aspects of the present disclosure will be described with reference to the following drawing figures wherein like reference numbers identify like parts throughout.

FIG. 1 is a perspective view of a coiling structure for a laser fiber according to one embodiment or aspect of the present disclosure;

FIG. 2 is a partially exploded perspective view of the coiling structure for a laser fiber shown in FIG. 1;

FIG. 3 is a partially transparent view of the coiling structure for a laser fiber shown in FIG. 1;

FIG. 4 is a side view of the coiling structure for a laser fiber shown in FIG. 1;

FIG. 5 is an exploded top perspective view of the coiling structure for a laser fiber shown in FIG. 1; and

FIG. 6 is an exploded bottom perspective view of the coiling structure for a laser fiber shown in FIG. 1.

### DESCRIPTION OF THE PREFERRED EMBODIMENTS

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

The term “includes” is synonymous with “comprises”.

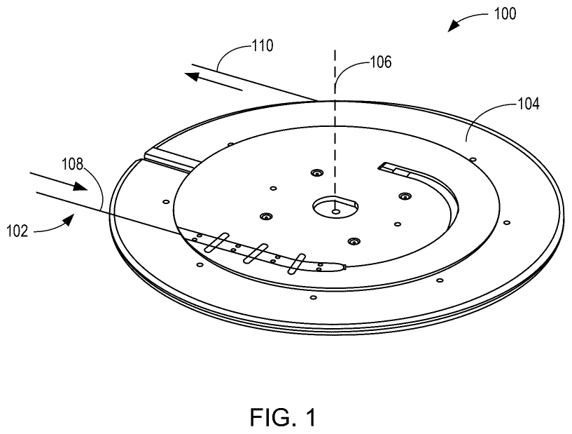

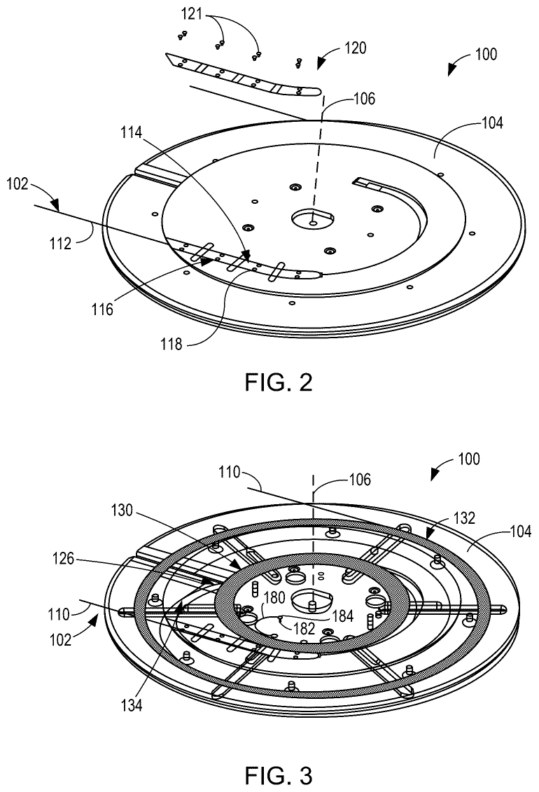

Referring to FIGS. 1-2, a coiling structure 100 for a laser fiber 102 is disclosed. In accordance with some embodiments or aspects of the present disclosure, the coiling structure 100 may be configured for use in high-power fiber laser systems. The coiling structure 100 is configured to contain a length of the laser fiber 102 in a coiled arrangement. As discussed herein, the coiling of the laser fiber 102 on the coiling structure 100 is used not only for spatial management of the laser fiber 102, but also for mode filtering and mitigation of nonlinear effects, such as SBS, which can degrade laser performance at high power levels. The mitigation of nonlinear effects is accomplished in some non-limiting examples by varying the coiling radius of the laser fiber 102 along its length. The disclosed coiling structure 100 allows for optimal mode management and enhanced power handling by utilizing different radial channels to coil the laser fiber 102 at different radii, as discussed herein.

The laser fiber 102 is an optical fiber used in fiber laser systems, where it serves as the medium for signal amplification. The laser fiber 102 may be doped with rare-earth elements, such as ytterbium or erbium, which provide the necessary gain when pumped with an external light source.

With continued reference to FIGS. 1-2, the coiling structure 100 has a body 104 with a central axis 106, around which the laser fiber 102 is coiled. The laser fiber 102 has an input end 108 where the laser fiber 102 enters the body 104 of the coiling structure 100 and an output end 110 where the laser fiber 102 exits the body 104 of the coiling structure 100. As shown in FIG. 2, the laser fiber 102 may have a passive fiber portion 112 that is fused with an active fiber portion 114 via a fusion splice 116. The body 104 of the coiling structure 100 may have a recess 118 configured to receive the fusion splice 116 and a removable cover 120 may be provided to protect the fusion splice 116. The removable cover 120 may be removably connectable to the body 104 of the coiling structure 100 via one or more cover fasteners 121 to cover the recess 118. The active fiber portion 114 is coiled in multiple loops within the body 104 of the coiling structure 100. As the signal travels through the active fiber portion 114, it undergoes optical amplification due to stimulated emission, resulting in a higher output power.

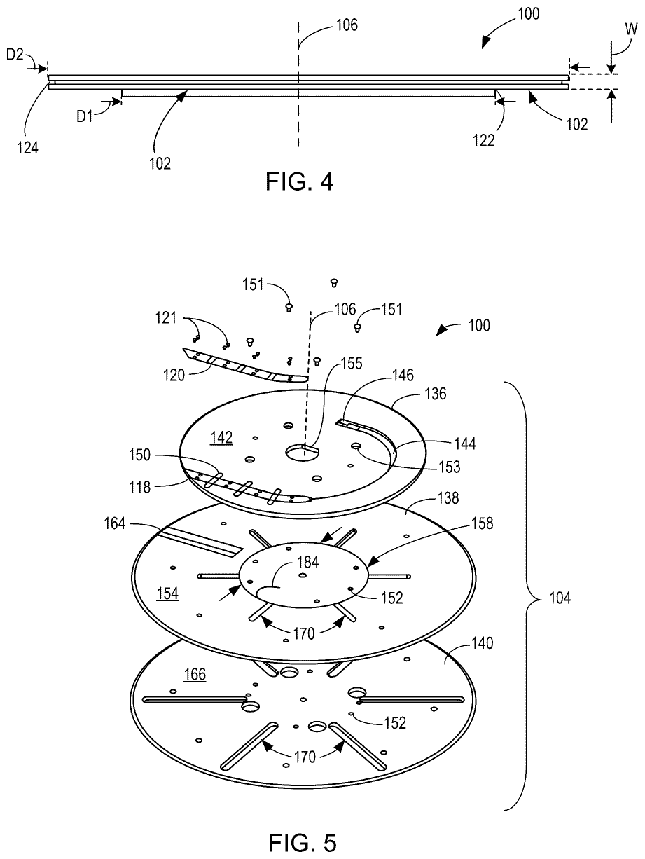

As shown in FIGS. 3-4, the body 104 features a plurality of radial channels, as discussed herein, positioned at different radii relative to the central axis 106. In a first radial channel 122 having a first diameter D1 (shown in FIG. 4), the laser fiber 102 is tightly coiled in a first coil 130 (shown in FIG. 3) near the input end 108, where mode filtering is crucial, while a second radial channel 124 has a second diameter D2 that is larger than the first diameter D1 at the output end 110 of the laser fiber 102, where high signal power requires a larger mode field area to suppress SBS. The first diameter D1 is determined by selection of the laser fiber 102, such as the mechanical properties of the laser fiber 102 to be bent at a specific radius without damaging the laser fiber 102. The first diameter D1 is also selected to achieve a single mode filtering. The second diameter D2 may be at least 20% larger than the first diameter D1.

With continued reference to FIGS. 3-4, the first radial channel 122 is positioned at a smaller radius from the central axis 106 and is configured to tightly coil the laser fiber 102 for mode filtering. The tight coiling in the first radial channel 122 helps filter higher-order core modes near the input end of the gain coil, where the gain is high and mode control is essential. The second radial channel 124 is positioned at a larger radius from the central axis 106 to accommodate a more relaxed coiling of the laser fiber 102 near the output end 110. This relaxed coiling reduces the optical intensity within the fiber core and lowers the susceptibility to SBS as the signal power increases.

With reference to FIG. 3, a transition section 126 connects the first and second radial channels 122, 124 allowing for a smooth transition between the different coiling radii along the length of the laser fiber 102. The transition section 126 is configured to provide a gradual change in the coiling radius of the laser fiber 102 to avoid abrupt bending of the fiber, which could lead to increased signal loss or damage. In one embodiment, the transition section 126 extends through the body 104 of the coiling structure 100, which helps guide the fiber smoothly from the first radial channel 122 to the second radial channel 124. In some embodiments, the transition section 126 is located where a predetermined length of laser fiber 102 in the first radial channel 122 is coiled.

With reference to FIG. 4, a width W of the first and second radial channels 122, 124 in the axial direction is chosen to correspond to the diameter of the laser fiber 102, typically in the range of, for example, 165 to 565 micrometers. This ensures that the laser fiber 102 fits snugly within the channels 122, 124, minimizing the risk of lateral displacement or damage. The channel width may be selected to accommodate different fiber diameters as required for specific laser applications.

As shown in FIG. 3, the laser fiber 102 is coiled into a first coil 130 in the first radial channel 122 and a second coil 132 in the second radial channel 124. A transition portion 134 of the laser fiber 102 connects the first coil 130 to the second coil 132 and extends through the transition section 126 of the body 104. The first coil 130 and the second coil 132 may be planar coils, wherein a diameter of the coiled laser fiber 102 continually increases with each successive coil. In some embodiments or aspects, the first coil 130 and the second coil 132 may be cylindrical coils, conical coils, or non-linear coils.

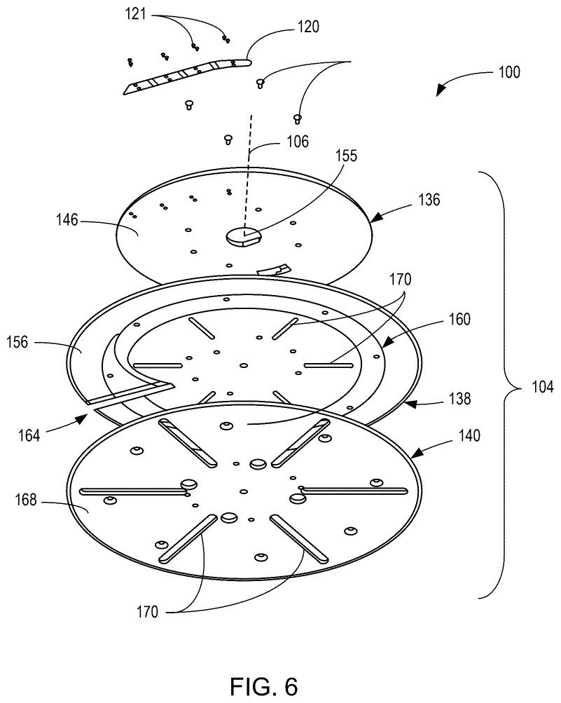

With reference to FIGS. 5-6, the body 104 of the coiling structure 100 may have a plurality of plates that are coaxially aligned along the central axis 106. This multi-plate arrangement allows for a straightforward assembly of the plates while maintaining precise control over the channel dimensions and alignment. Additionally, using plates enables the structure to be easily disassembled for maintenance or replacement of the laser fiber 102.

In some embodiments or aspects, and with continued reference to FIGS. 5-6, the body 104 may have a first plate 136, a second plate 138, and a third plate 140 that are coaxially aligned along the central axis 106. The first, second, and third plates 136, 138, 140 may be removably or non-removably connected together. In some embodiments or aspects, the first, second, and third plates 136, 138, 140 are removably connected together via a one or more fasteners 151 received in corresponding holes 153.

The first, second, and third plates 136, 138, 140 have surfaces that define the first radial channel 122 and/or the second radial channel 124 (shown in FIG. 3) for receiving the laser fiber 102. For example, the first radial channel 122 may be defined between a lower surface of the first plate 136 and an upper surface of the second plate 138, while the second radial channel 124 may be defined between a lower surface of the second plate 138 and an upper surface of the third plate 140. The first, second, and third plates 136, 138, 140 are configured to provide support and containment for the laser fiber 102 as it is wound in the first and second radial channels 122, 124.

With reference to FIG. 5, the first plate 136 has a substantially planar structure having an upper surface 142 that defines an inlet groove 144 that serves as an entry point for the laser fiber 102 into the coiling structure 100. The inlet groove 144 may have a passthrough channel 146 extending from the upper surface 142 to a lower surface 148 (shown in FIG. 6) of the first plate 136 in order to guide the laser fiber 102 into the first radial channel 122 as the laser fiber 102 enters the coiling structure 100. The first plate 136 further may have the recess 118 configured to receive the fusion splice 116 of the laser fiber 102 (shown in FIG. 2). Furthermore, the first plate 136 may have openings 150 on its upper surface 142 configured to receive respective fasteners 121 for removably connecting the removable cover 120 to the first plate 136. In some embodiments or aspects, the first plate 136 has a central opening 155 configured for mounting of a drive portion of a coiling mechanism for rotating the coiling structure 100 during a coiling operation.

With continued reference to FIGS. 5-6, the second plate 138 is positioned between the first plate 136 and the third plate 140. The second plate 138 has a substantially planar structure having an upper surface 154 (FIG. 5) opposite a lower surface 156 (FIG. 6). The second plate 138 has a first protrusion 158 (shown in FIG. 5) extending axially outward from the upper surface 154, which defines an inner radial surface of the first radial channel 122. A diameter of the first protrusion 158 defines the diameter of the first radial channel 122 (shown in FIG. 4). The second plate 138 also has a second protrusion 160 (shown in FIG. 6) extending axially outward from the lower surface 156, which defines an inner radial surface of the second radial channel 124. A diameter of the second protrusion 160 defines the diameter of the second radial channel 124 (shown in FIG. 4). The second plate 138 also has a transition passage or groove 164 extending from the upper surface 154 to the lower surface 156 that allows the laser fiber 102 to pass from the first radial channel 122 to the second radial channel 124.

With continued reference to FIGS. 5-6, the third plate 140 has a substantially planar structure having an upper surface 166 (FIG. 5) opposite a lower surface 168 (FIG. 6). The upper surface 166, together with the lower surface 156 of the second plate 138 defines the upper and lower ends of the second radial channel 124. In some embodiments or aspects, the third plate 140 and the second plate 138 may have a plurality of slots 170 spaced apart from each other axially and extending in a radial direction. The slots 170 permit visual observation of the laser fiber 102 in the first radial channel 122 and the second radial channel 124 to assure proper winding quality.

The body 104, including the first, second, and third plates 136, 138, 140, may be formed from a thermally-conductive material such as aluminum, copper, or a heat-conductive composite. The material selection helps dissipate heat generated by the laser fiber 102 maintaining the integrity and performance of the laser fiber 102 during operation. The use of a thermally-conductive material enhances heat dissipation, preventing the laser fiber 102 from overheating during high-power operation. This feature is particularly advantageous in fiber laser systems that require sustained high power output over extended periods. In some embodiments or aspects, the coiling structure 100 may have a cooling arrangement to provide a further cooling effect.

In some embodiments, the laser fiber 102 may be coiled concurrently in the first radial channel 122 with a metal wire 180 shown in FIG. 3. The metal wire 180 may be made of copper or other heat-conductive material and is configured for providing additional thermal conduction path for the laser fiber 102 in the first radial channel 122 where greatest heat transfer occurs. The metal wire 180 also spaces the coils of the laser fiber 102 in the first radial channel to control self-heating of the laser fiber 102. In some embodiments, a first end 182 of the metal wire 180 may be secured in a hook 184 on the second plate 138 (see FIG. 5).

Although various embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A coiling structure for a laser fiber, the coiling structure comprising:
a body having a central axis;
a first radial channel in the body positioned at a first radius from the central axis;
a second radial channel positioned at a second radius from the central axis; and
a transition section connecting the first radial channel to the second radial channel,
wherein the second radius is larger than the first radius.

2. The coiling structure according to claim 1, wherein the body comprises a first plate, a second plate, and a third plate coaxially aligned with the central axis.

3. The coiling structure according to claim 2, wherein the first radial channel is defined between the first plate and the second plate, wherein the second radial channel is defined between the second plate and the third plate, and wherein the transition section extends through the second plate.

4. The coiling structure according to claim 2, wherein the second plate has a first protrusion extending axially outward from a first surface, the first protrusion defining an inner radial surface of the first radial channel, and wherein the first plate has a second protrusion extending axially outward from a second surface opposite the first surface, the second protrusion defining an inner radial surface of the second radial channel.

5. The coiling structure according to claim 1, wherein a width of the first radial channel and the second radial channel in an axial direction corresponds to a diameter of the laser fiber.

6. The coiling structure according to claim 2, wherein the first plate comprises an inlet groove having a passthrough channel extending into the first radial channel.

7. The coiling structure according to claim 1, wherein the body is made from a thermally-conductive material.

8. A laser fiber gain coil comprising:
a body having a central axis;
a first radial channel in the body positioned at a first radius from the central axis;
a second radial channel positioned at a second radius from the central axis, wherein the second radius is larger than the first radius;
a transition section connecting the first radial channel to the second radial channel; and
a laser fiber having a first portion wound in a first coil in the first radial channel, a transition portion extending through the transition section, and a second portion wound in a second coil in the second radial channel.

9. The laser fiber gain coil according to claim 8, wherein the first coil and the second coil are planar coils.

10. The laser fiber gain coil according to claim 8, wherein the first coil and the second coil are cylindrical coils.

11. The laser fiber gain coil according to claim 8, wherein the first portion of the laser fiber comprises a metal wire extending parallel with the first portion.

12. The laser fiber gain coil according to claim 8, wherein the laser fiber is a glass fiber comprising a polymeric coating.

13. The laser fiber gain coil according to claim 8, wherein the body comprises a first plate, a second plate, and a third plate coaxially aligned with the central axis.

14. The laser fiber gain coil according to claim 13, wherein the first radial channel is defined between the first plate and the second plate, wherein the second radial channel is defined between the second plate and the third plate, and wherein the transition section extends through the second plate.

15. The laser fiber gain coil according to claim 14, wherein the second plate has a first protrusion extending axially outward from a first surface, the first protrusion defining an inner radial surface of the first radial channel, and wherein the first plate has a second protrusion extending axially outward from a second surface opposite the first surface, the second protrusion defining an inner radial surface of the second radial channel.

16. The laser fiber gain coil according to claim 8, wherein a width of the first radial channel and the second radial channel in an axial direction corresponds to a diameter of the laser fiber.

17. The laser fiber gain coil according to claim 13, wherein the first plate comprises an inlet groove having a passthrough channel extending into the first radial channel.

18. The laser fiber gain coil according to claim 8, wherein the body is made from a thermally-conductive material.
